(19) United States
(12) Patent Application Publication
(10) Pub. No.: US 2002/0082998 A1
(43) Pub. Date: Jun. 27, 2002

(54) Capturing intellectual capital via digital collaboration

(76) Inventors: Bharat Sastri, Pleasanton, CA (US); Charles Kuta, Los Gatos, CA (US); Joseph Tung, Cupertino, CA (US)

Correspondence Address: Fabio E. Marrino, SKJERVEN MORRILL MacPHERSON LLP, Suite 700, 25 Metro Drive, San Jose, CA, 95110-1349, US

(21) Appl. No.: 09/964,230

(22) Filed: Sep. 25, 2001

Related U.S. Application Data
(63) Continuation-in-part of application No. 09/494,792, filed on Jan. 31, 2000.
Application No. 09/494,792 is a continuation-in-part of application No. 09/591,991, filed on Jun. 12, 2000.

(51) Int. Cl. G06F 17/60

(52) U.S. Cl. 705/51

(57) ABSTRACT

A system and method are provided that allow users of a digital collaboration service to share information in such a way that an accurate record of the information shared during the digital collaboration is captured. Furthermore, the context in which the information is being exchanged amongst users of the service can also be captured. As a result, a system in accordance to one or more embodiments of the present invention is ideally suited for digital collaboration conducted amongst potential business partners, where maintaining an accurate record of what information was shared by each party is paramount. Furthermore, the capture of contextual information makes a system in accordance to one or more embodiments of the present invention ideally suited for digital collaboration conducted amongst users that are within the same company. For example, a development team may use a digital collaboration system in accordance to the present invention to conduct meetings. Since any part of the digital collaboration session, including all of the relevant contextual information, is captured an accurate record of the information exchanged during the digital collaboration session may be automatically generated.

### CROSS-REFERENCE TO RELATED APPLICATIONS

This application is a continuation-in-part of co-pending application Ser. No. 09/494,792 filed on Jan. 31, 2000 by Joseph Tung and Bharat Sastri which is incorporated by reference herein in its entirety. This application is also a-continuation-in-part of copending application Ser. No. 09/591,991 filed on Jun. 12, 2000 by Joseph Tung and Bharat Sastri which is incorporated by reference herein in its entirety.

### BACKGROUND OF THE INVENTION

1. Field of the Invention

The present invention relates generally to data communication systems and, more particularly, to digital collaboration systems.

2. Related Art

As high-technology companies compete to streamline the development process and achieve faster time-to-market for their products, individual companies have focused on a particular sector of the industry. In such a business environment, companies with specialized expertise in one technological area often find it inefficient to spend the time and resources necessary to develop technology in different technological areas. As a result, these companies may gain a competitive advantage by contracting out the development effort in the new technology area to another company with expertise in that technological area. Currently, however, the process of identifying potential partners for the development of complex technological solutions presents significant obstacles. For example, there may be no universally accepted way of explaining the project for which a partner is sought. As a result, the very process of defining the project for which a solution provider is sought may require expertise in the new technology.

Furthermore, security concerns prevent free sharing of information among potential business partners. While companies who decide to share information with potential partners typically enter into non-disclosure agreements, there currently is no practical way to ensure that an accurate record of the information shared is preserved.

There is thus a need of a way to allow companies to share information about potential business collaborations that allows an accurate record of what information is shared to be kept.

In addition, current digital collaboration systems do not allow users to automatically capture the information shared during a collaboration session. Thus, the only records of current digital collaboration sessions are the notes taken by the participants.

There is thus a need for a system that allows improved record keeping of exchanges among participants that take place during digital collaboration sessions.

### SUMMARY OF THE INVENTION

The system and method of the present invention allow users of a digital collaboration service to share information in such a way that an accurate record of the information shared during the digital collaboration is captured

Furthermore, the context in which the information is being exchanged amongst users of the service can also be captured. As a result, a system in accordance to one or more embodiments of the present invention is ideally suited for digital collaboration conducted amongst potential business partners, where maintaining an accurate record of what information was shared by each party is paramount.

Furthermore, the capture of contextual information makes a system in accordance to one or more embodiments of the present invention ideally suited for digital collaboration conducted amongst users that are within the same company. For example, a development team may use a digital collaboration system in accordance to the present invention to conduct meetings. Since any part of the digital collaboration session, including all of the relevant contextual information, is captured an accurate record of the information exchanged during the digital collaboration session may be automatically generated.

### BRIEF DESCRIPTION OF THE DRAWINGS

FIG. 1A is a block diagram of a computer system providing a service for exchanging solutions to individualized problems.

FIG. 1B is a data flow diagram of the computer system of FIG. 1A.

FIG. 2A is a block diagram of a computer system for providing a private service for exchanging solutions to individualized problems.

FIG. 2B is a block diagram of a computer system for automatically capturing digital collaboration information, in accordance to some embodiment, of the invention.

FIG. 3A is a flow diagram of the process of accessing the service of FIGS. 1A and 1B for a solution seeker.

FIG. 3B is a detailed flow diagram of the discuss/validate stage of FIG. 3A.

FIG. 4A is a flow diagram of the process of accessing the service of FIGS. 1A and 1B for a solution provider.

FIG. 4B is a flow diagram of the process of conducting a digital collaboration capture operation, in accordance to some embodiments of the invention.

FIG. 5A is a flow diagram of the process of accessing the private service of FIG. 2A for a solution seeker.

FIG. 5B is a flow diagram of the process of accessing the private service of FIG. 2A for a solution provider.

FIG. 6A is a block diagram of the flow of information between a solution seeker and a project definition provider, according to an embodiment of the present invention.

FIG. 6B is a flow diagram of the process of obtaining a project definition for a solution seeker.

FIG. 6C is a flow diagram of the process of providing a project definition for a project definition provider.

FIG. 7A is a block diagram of the flow of information between a solution seeker and a solution testbed provider.

FIG. 7B is a flow diagram of the process of obtaining a testbed for a solution seeker.

FIG. 7C is a flow diagram of the process of providing a testbed for a solution testbed provider.

FIG. 8 shows a web page of a third party service provider of FIG. 2A.

FIGS. 9A and 9B show a project definition web page.

FIG. 10 shows a project summary web page.

FIGS. 11A and 11B illustrate a project detail and a proposal detail web page.

FIG. 12 shows a project discussion web page.

FIGS. 13A and 13b illustrate a project search and a project detail web page.

FIG. 14 shows a solution proposal web page.

FIG. 15 shows an administrator web page used to set security parameters in the computer system of FIG. 2A.

FIG. 16 illustrates a set user password web page.

FIG. 17A illustrates a select contact web page.

FIG. 17B illustrates an adjust contact roles web page.

FIG. 18A illustrates an adjust roles users web page.

FIG. 18B illustrates an adjust role privileges web page.

FIG. 18C illustrates an adjust security trust web page.

FIG. 19 shows a submit entry token web page.

FIGS. 20 and 21A-21C are block diagrams illustrating IP packets used by the digital collaboration system of FIG. 2B.

### DETAILED DESCRIPTION OF THE INVENTION

The present invention provides a service for automatically capturing digital collaboration information. In some embodiments, the digital collaboration data is exchanged between solution seekers and solution providers.

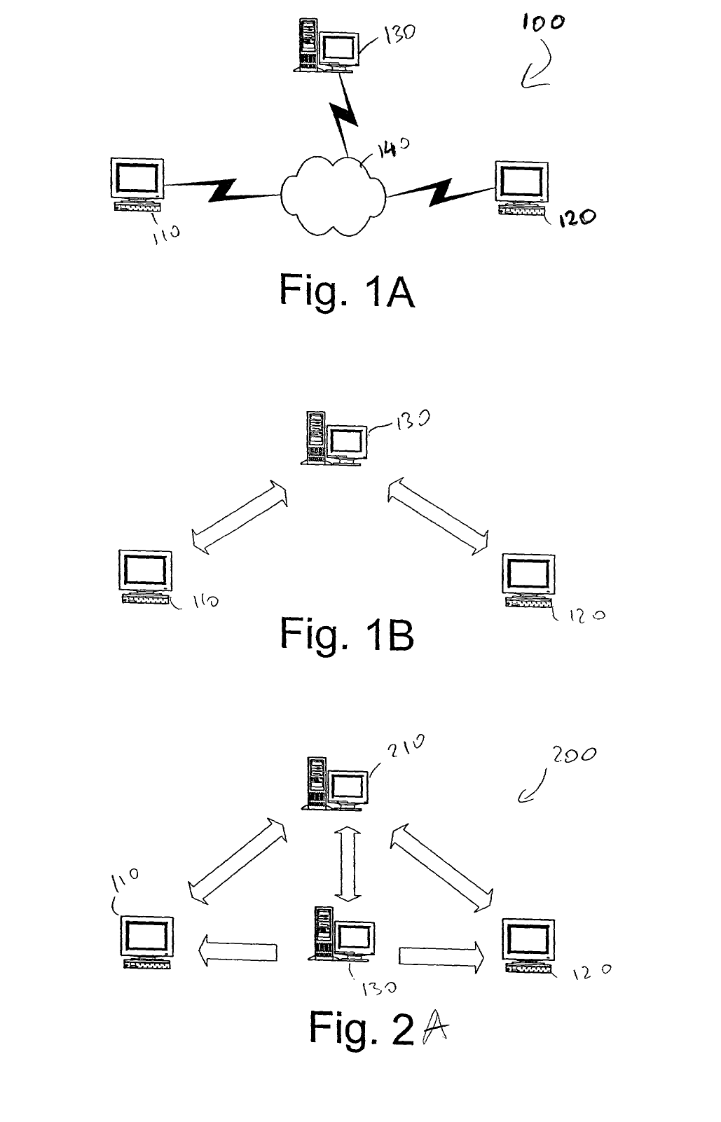

FIG. 1A illustrates of a computer system 100 providing a service for exchanging solutions to individualized problems between solution seekers and solution providers, in accordance with an embodiment of the present invention. Computer system 100 includes a solution seeker computer 110, a solution provider computer 120, and a solution broker computer 130 connected via a global-area computer network 140. Solution seeker computer 110 and solution provider computer 120 are any suitable computers for transferring and processing information over global-area computer network 140, including but not limited to personal computers, workstations, servers, etc. Global-area computer network 140 is computer network used to connect computers regardless of their geographical location, such as the Internet. Software programs necessary to provide communications over global-area computer network 140 are executed by solution seeker computer 110, solution provider computer 120 and solution broker computer 130. These software programs include operating system programs such as Windows98/NT/2000, MacOS9 or Unix, web browsers such as Internet Explorer or Netscape Navigator, and a variety of application programs (e.g. MS Office).

As shown in FIG. 1B, solution provider computer 110 and solution seeker computer 120 do not exchange information directly. Rather, solution broker computer 130 acts as a proxy server between solution seeker computer 110 and solution provider computer 120.

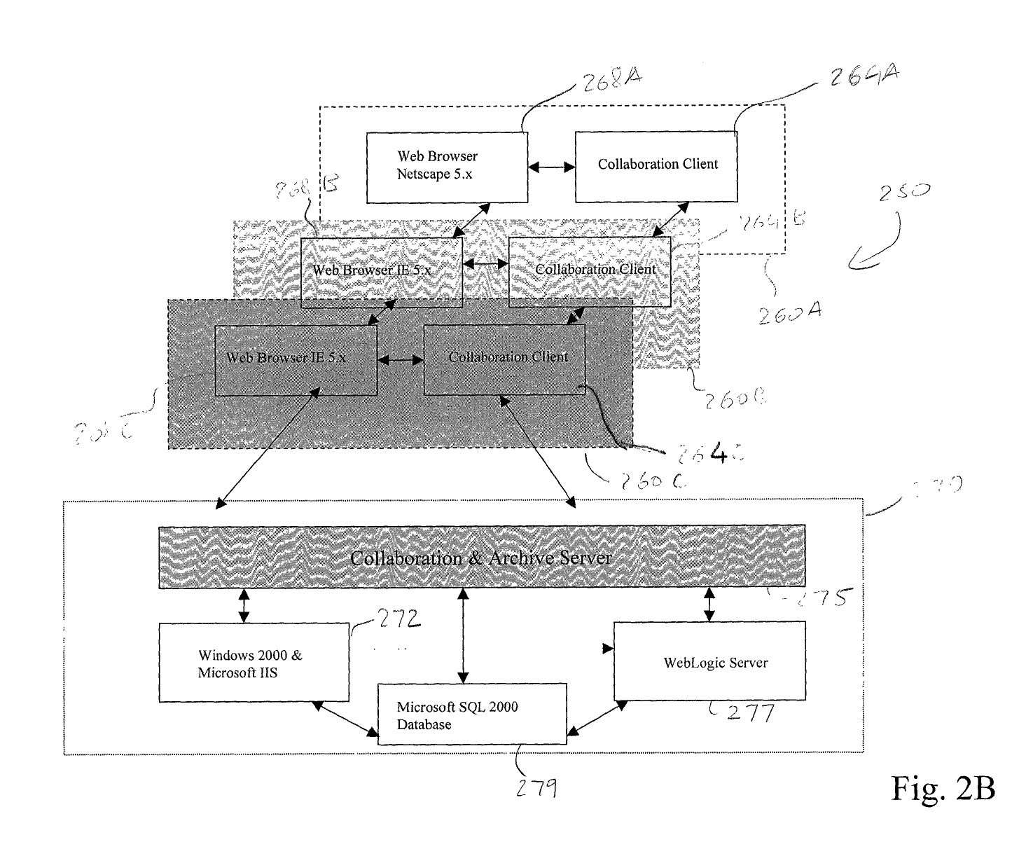

FIG. 2A illustrates the flow of data in a computer system 200 providing a private service for exchanging solutions to individualized problems between solution seekers and solution providers, in accordance with an embodiment of the present invention.

Computer system 200 operates in a manner similar to computer system 100, except that solution seeker computer 110 and solution provider computer 120 do not communicate directly with solution broker computer 130, but rather through a private service computer 210. In some embodiments, however, solution broker computer 130 and private service computer 210 may be implemented as two separate processes executed by a single physical computer. In such cases, communications between solution broker computer 130 and private service computer 210 would not occur over a computer network, but rather would be internal exchanges of information between processes executed on a common hardware platform.

FIG. 2B illustrates a digital collaboration system 250, in accordance to some embodiments of the invention. Digital collaboration system 250 includes a server computer 270 and a plurality of client computers 260n (where n=A, B, C . . . ). Client computers 260n can be any type of personal computer or workstation known in the art, e.g. a Sun Sparc workstation, an Intel Pentium II-based laptop computer or an Intel Pentium III-based personal computer, running any operating system suitable for such computer, e.g. Sun Solaris, Microsoft Windows 98, Microsoft Windows 2000 and the like. Server computer 270 can be any type of computer suitable for network data storage operations, such as a Sun Sparc workstation or a dual Intel Pentium III-based computer running any operating system suitable for that computer, e.g. Windows 2000, Windows NT 4.0, Sun Solaris, Linux and the like.

Each client computer 260n, in turn, includes a web browser 268n and a collaboration client 264n. Web browser 268n can be any type of web browser known in the art, e.g. Netscape Navigator 5.x or Internet Explorer 5.x. Collaboration client 264n is a program that can be configured to automatically capture and tag information exchanged during a digital collaboration session. In some embodiments, collaboration client 264n is implemented as a JAVA applet that inserts XML tags into IP packets transmitted from client computer 260n to server computer 270, as described further below.

Server computer 270, in turn, includes collaboration & archive server 275, operating system 272, a database 279 and an a server program 277. Collaboration & archive server 275 is a program that receives the tagged data captured by collaboration clients 260n and stores them into database 279 for later analysis and re-use. In some embodiments, operating system 272 is the Windows 2000 operating system from Microsoft. Windows 2000 includes an Internet Information Server (IIS) component used to support web servers. In some embodiments, database 279 is Microsoft SQL 2000 and server program 277 is a WebLogic server program.

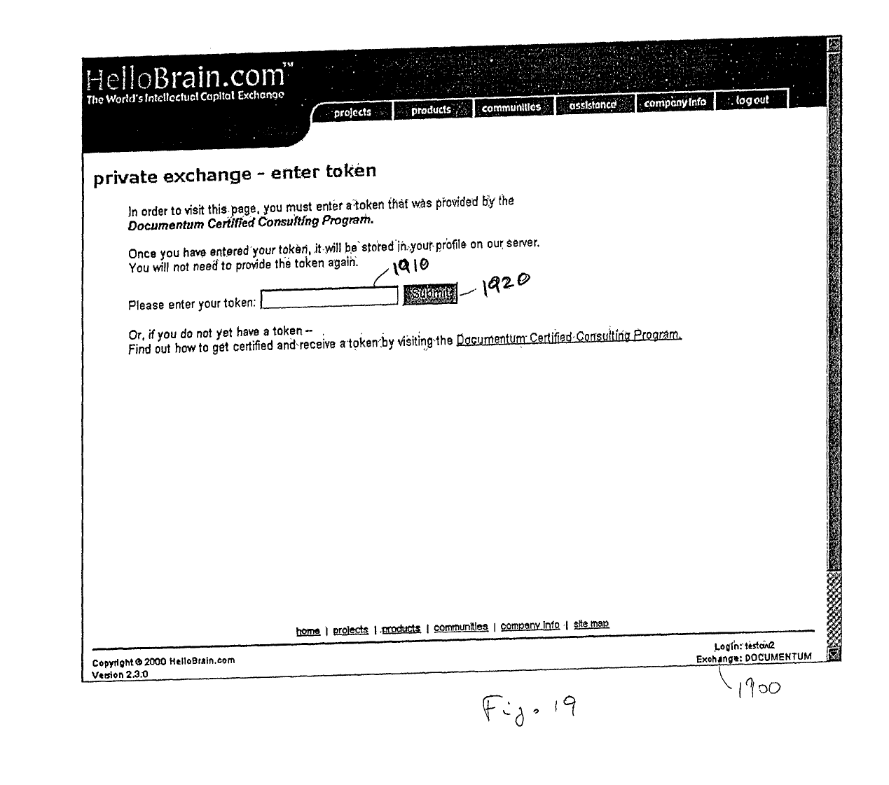

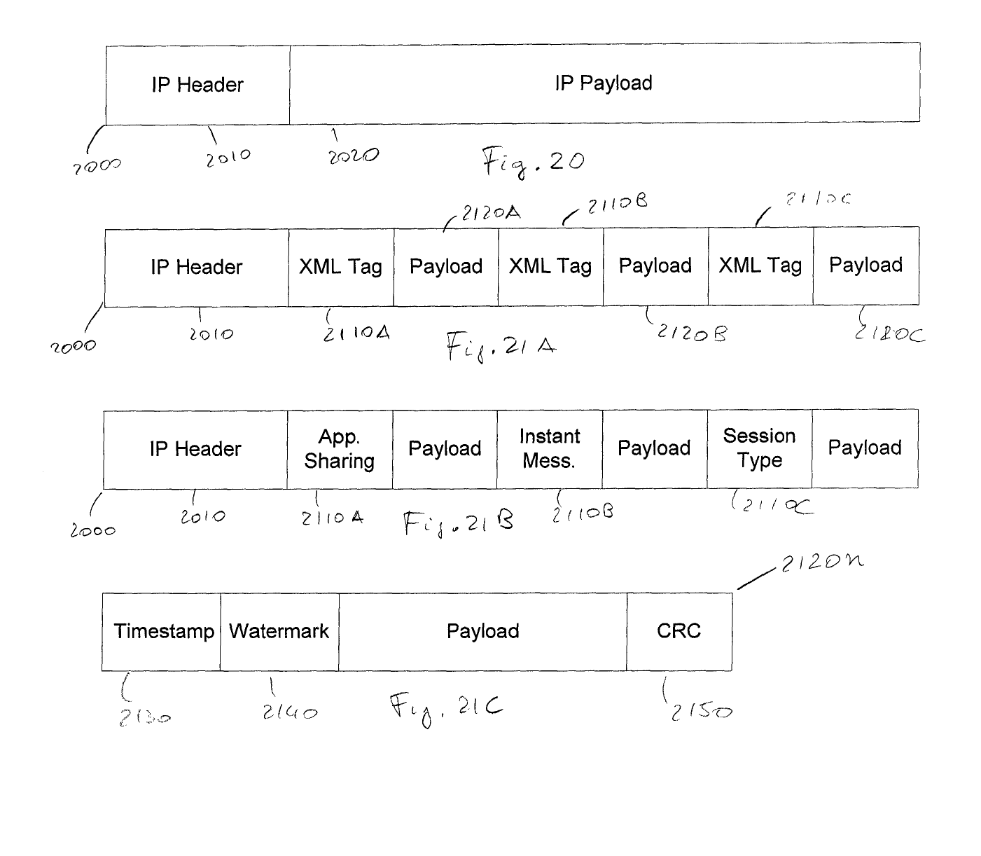

FIGS. 20 and 21A-21C are block diagrams illustrating how IP packets are modified by collaboration client 264n (FIG. 2B) to capture and tag digital collaboration information, in accordance to some embodiments of the invention.

FIG. 20 illustrates a typical IP packet 2000, including an IP header 2010 and an IP payload 2020.

FIG. 21A illustrates an IP packet 2000 after it has been modified by collaboration client 264n to include a plurality of XML tags 2110n and corresponding payloads 2120n , where (n=A, B, C . . . ). FIG. 21B shows how different XML tags 2110n are used to specify a type of communication used during a digital collaboration session, e.g. application sharing, instant messaging, session type and the like. Finally, FIG. 21C illustrates how collaboration client 264n, in some embodiments, may embed information such as a timestamp 2130, a watermark 2140 or an error correcting code 2150 into payloads 2120n .

During a collaboration session, each source of communication (e.g. a whiteboard, a desktop or an application) is associated with a port by digital collaboration system 250 (FIG. 2B). Digital collaboration information is then captured for each port selected by the user. As a result, the data captured for any of the selected ports can then be retrieved and replayed at a later time, thereby preserving the context in which the information was originally presented during the collaboration session.

It should be noted that since collaboration capture operations are performed at the TCP/IP interface, digital collaboration can be conducted transparently between client computers 260n that have different software and/or hardware platforms. In fact, data captured on one client computer 260n can be later replayed on a different client computer 260n regardless of the software and hardware configurations of the client computers 260n. For example, digital collaboration information originally generated on a Sun Sparc workstation running under the Solaris operation system, can be later replayed on an Intel II-based laptop computer running under Windows 98.

The capabilities of digital collaboration system 250 are further described in Appendix A, which is part of the present disclosure.

In particular, digital collaboration system 250 supports multiple participants digital collaboration sessions where information from one user is broadcasted to all other users, rather than simply being posted on a web page as in prior art digital collaboration systems. WebLogic server 277, in turn, is used to broadcast the information to the other session participants.

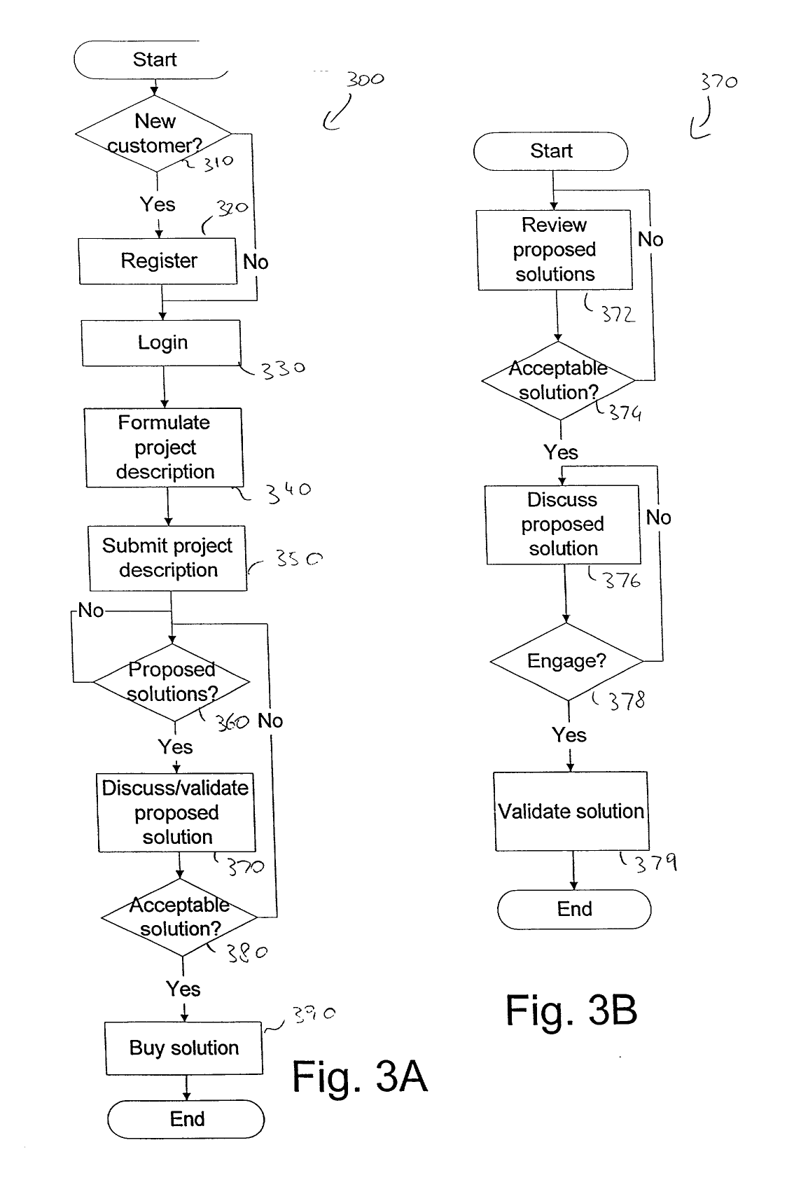

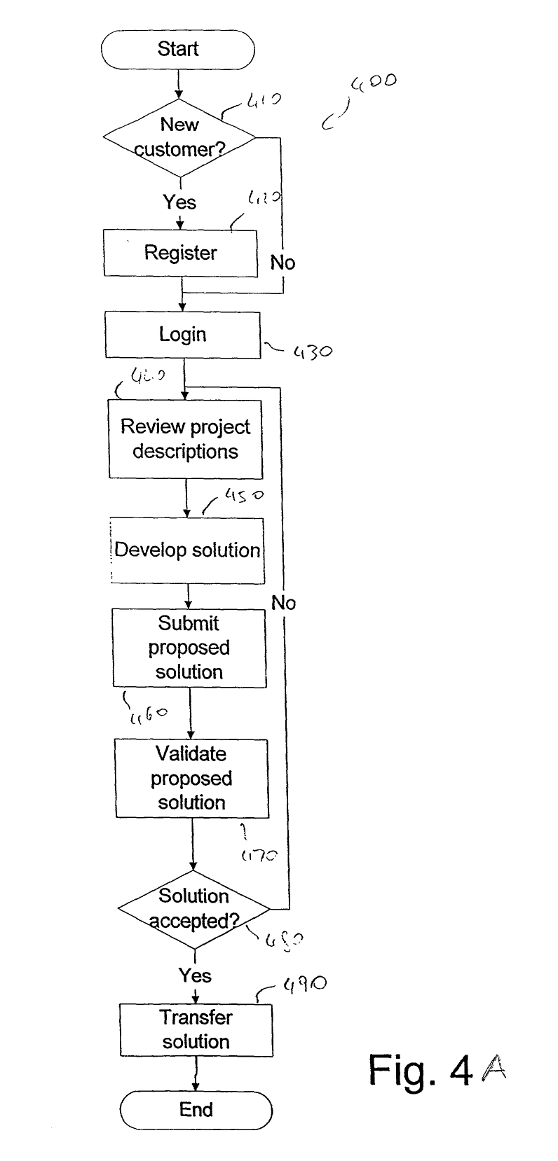

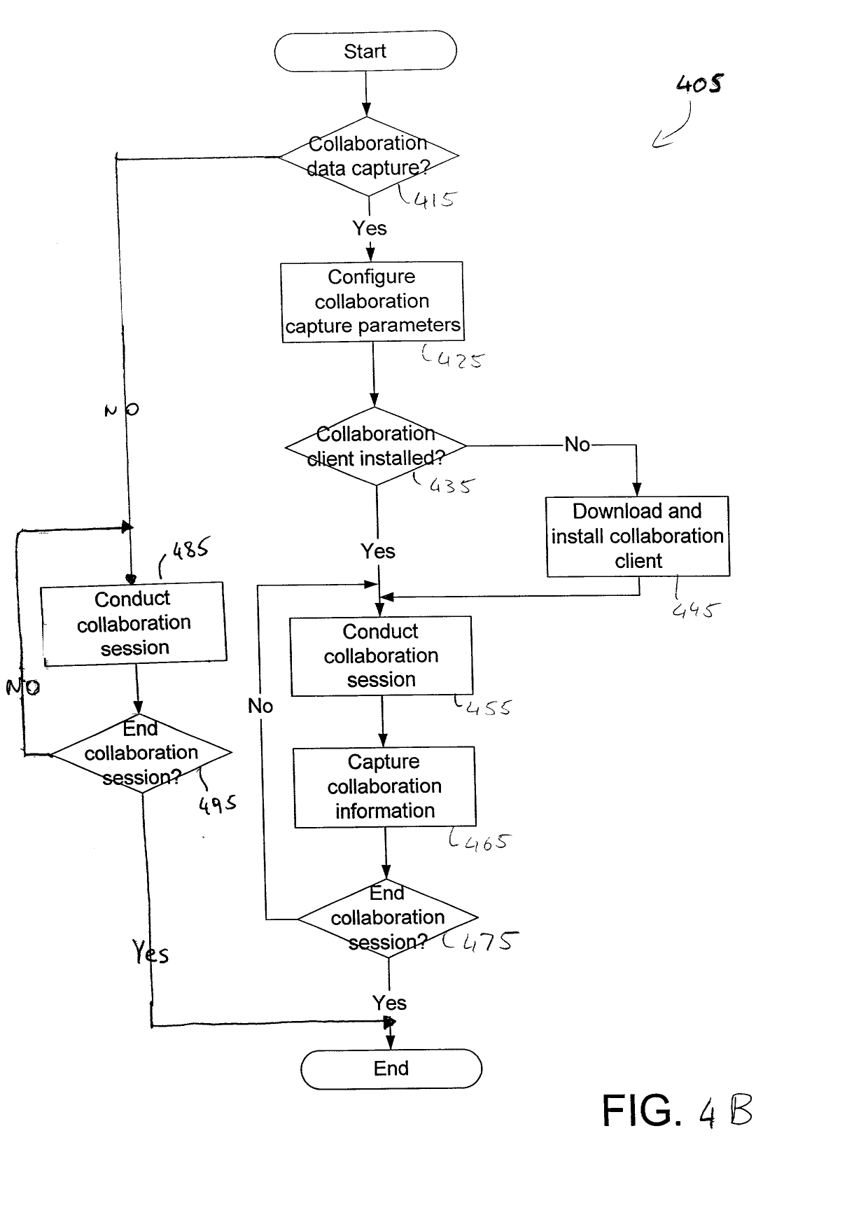

The process 300 of accessing a service provided by computer system 100 for a solution seeker is illustrated by the flow diagram of FIG. 3A. First, stage 310 determines whether the solution seeker is a new customer of the service, in which case the solution seeker registers as a new user of the service in stage 320. Otherwise, the solution seeker logs in to the service in stage 330. In stage 340, the solution seeker formulates a project description. The solution seeker may enlist the help of project definition providers in formulating the project definition through the service. Project definition providers are third parties with technical expertise in the area of the solution seeker project who would help the solution seeker in translating an initial definition of the project provided by the solution seeker into a technically accurate definition to be posted on the service. Once the project description has been satisfactorily formulated, the solution seeker submits the project definition to the service in stage 350. The project definition is checked by the service provider and posted onto a solution broker website maintained by solution broker computer 130. The solution broker website is only accessible to registered users to protect the confidentiality of the information provided over the solution broker website. Once the project definition is posted on the solution broker website, it becomes available to potential solution providers for viewing and searching. Solution providers may then submit proposed solutions in response to the project definition. In addition, a search engine compares the project definition against a database of registered solution providers and sends a message to suitable solution providers alerting the solution providers to the project definition posted by the solution seeker. In stage 360, the solution seeker then checks to see if any proposed solutions have been submitted in response to the project definition, in which case the proposed solution is validated in stage 370. As part of the validation process, the solution seeker and the solution provider may discuss the project definition and the proposed solution using a collaboration forum (e.g. a chat room, message board, voice, empathic validation, net meeting, etc.) provided by the solution broker. This process is illustrated by the flow diagram of FIG. 3B. First, the solution seeker reviews a proposed solution in stage 372. In stage 374, the solution seeker then determines whether the proposed solution is acceptable, in which case operation 370 proceeds to stage 376. Otherwise, the solution seeker reviews another proposed solution and stages 372-374 are repeated until either the solution seeker finds an acceptable solution or all proposed solutions have been considered and rejected by the solution seeker. In stage 376, the solution seeker and the solution provider discuss the project definition and/or the proposed solution. In stage 378, the solution seeker determines whether to engage the solution provider, in which case the proposed solution is validated in stage 379. Otherwise, the solution seeker and the solution provider may continue discussions or abandon the process altogether. In some embodiments, the discussion room provides support fort for electronic payments, file and electronic signature exchange. In some embodiments, an immediate voice messaging service is provided to instantly connect users. The immediate messaging service operates by installing monitoring software onto a user computer that detects a request to establish a connection received from solution broker computer 130 and alerts the user of the communication request. In addition, communications between solution seekers and solution brokers are recorded to preserve an accurate record of the information exchanged. If multiple proposed solutions have been submitted, the solution seeker may choose a particular solution for validation/discussion or conduct validation on multiple competing solutions. In stage 380, the solution seeker determines whether the proposed solution is acceptable, in which case the solution seeker may buy the solution in stage 390. Otherwise, stages 360-380 are repeated until an acceptable solution is received by the solution seeker.

In some embodiments, additional parties may become involved in the process of defining a project and developing a solution. For example, parties with expertise in one area may advise solution seekers to reframe their project definitions in different terms—a process referred to as re-orienting the solution seeker. Other parties may contribute financially to the resolution of the problem in exchange for an interest in the solution. Finally, the solution broker may intervene to recategorize the project definition to make it more easily searchable in the solution broker's database. In addition, the solution broker may decide to outsource or delegate some or all of its function to third parties. These third parties would then receive a commission on any fees collected by the solution broker.

Solution broker computer 130 tracks and timestamps all information transferred between solution seeker computer 110 and solution provider computer 120. As a result, an accurate record of what information was transferred when is maintained. In the event a dispute where to arise at a later time between solution seekers and solution providers as to the ownership of certain intellectual property, the records maintained by the solution broker would provide an accurate picture of the information exchanged between the parties. As a result, the solution broker acts as a “virtual notary” in the communications between solution seekers and solution providers.

The service of the present invention further provides an escrow service for the delivery of a solution from the solution provider to the solution seeker. A fee is charged for the service provided by the solution broker only if a solution is successfully transferred between the solution seeker and the solution provider. In addition, to encourage qualified solution seekers and solution providers to use the solution broker's website, solution providers are rated based on the number and value of the solutions actually transferred to solution seekers. These ratings might be used both to direct subsequent project definitions to solution seekers and to adjust the fees charged to the solution provider for the services of the solution broker. Similarly, solution seekers are rated based on the number and value of solutions actually acquired from solution providers, relative to the overall number and value of project definitions posted on the solution broker's website. These ratings are used in adjusting the fee charged to the solution seeker for the services of the solution broker.

The process of validating a proposed solution is described in detail in co-pending application Ser. No. 09/494,792.

The process 400 of accessing a service provided by computer system 100 for a solution provider is illustrated by the flow diagram of FIG. 4A. First, stage 410 determines whether the solution provider is a new customer of the service, in which case the solution provider registers as a new user of the service in stage 420. Otherwise, the solution provider logs in to the service in stage 430. Once logged in, the solution provider can review project definitions posted on the solution broker's website in stage 440 that match the solution provider's areas of expertise based on the solution provider's profile. The solution provider may also search for additional project definitions either via a search engine or by browsing through project definitions listed by category. The solution provider then develops a solution in response to the project definition in stage 450. The solution may be a product the solution provider has already developed, a customization to an existing product or a product to be developed based on the project definition. The solution provider then submits his proposed solution in stage 460. The proposed solution is then validated in stage 470. As part of the validation process, the solution seeker may provide a testbed to the solution provider to test the functionality of the proposed solution. The solution seeker then determines whether to accept any of the proposed solutions in stage 480, in which case, the proposed solution is transferred from the solution provider to the solution seeker through the solution broker. Otherwise, stages 440-490 are repeated.

The process 405 of automatically capturing digital collaboration information is illustrated by the flow diagram of FIG. 4B. First, stage 415 determines whether a user wants to use the collaboration data capture service, in which case, operation 405 proceeds to stage 425. Otherwise, operation 405 proceeds to stage 485. In stage 425, the user adjusts one or more collaboration parameters. For example, the user may select what type of collaboration events are to be captured, which collaboration sessions participant' contributions are to be captured and the like. While collaboration capture parameters are typically configured prior to a collaboration session, in some embodiments these parameters may be also dynamically adjusted during the collaboration session. Stage 435 then determines whether a collaboration client 264n (FIG. 2B) is already installed on client computer 260n, in which case operation 405 proceeds to stage 455. Otherwise, a suitable collaboration client 264n is downloaded and installed on client computer 260n in stage 445 and operation 405 proceeds to stage 455. In stage 455, a collaboration session is conducted. In stage 465, the selected portions of the collaboration information are captured according to the parameters configured in stage 425. Stage 475 then determines whether the collaboration session has ended, in which case operation 405 terminates. Otherwise, stages 455-475 are repeated. In stage 485, a collaboration session is conducted. Stage 495 then determines whether the collaboration session has ended, in which case operation 405 terminates. Otherwise, stages 485-495 are repeated.

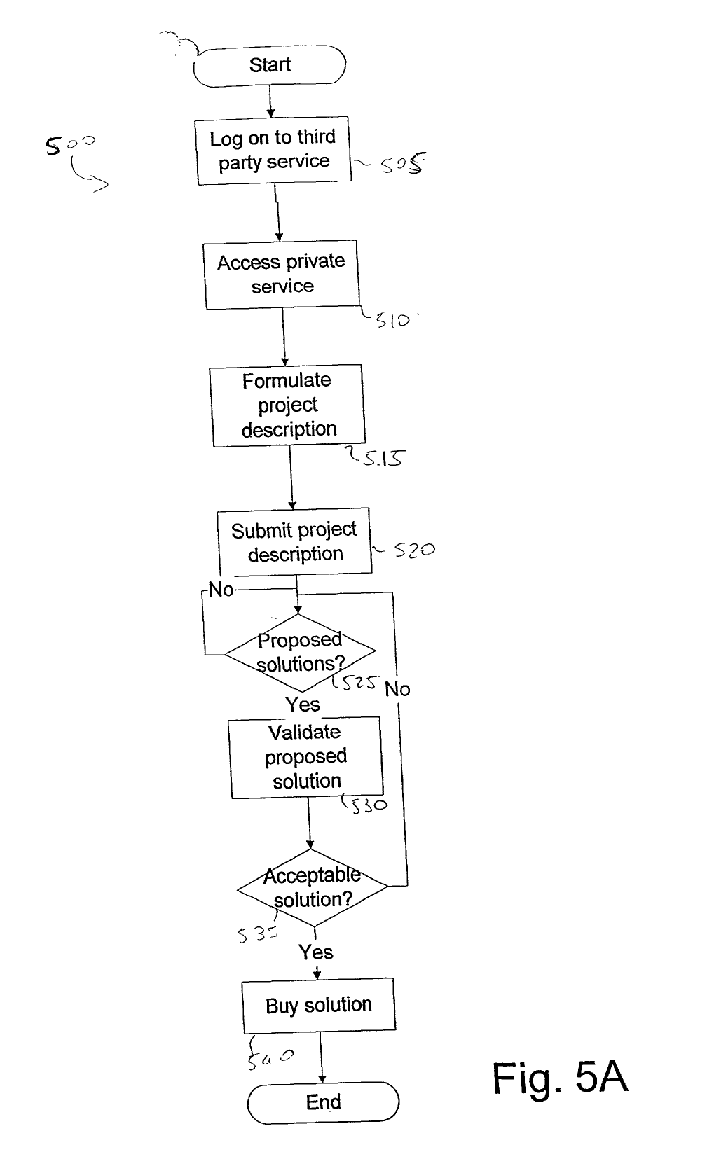

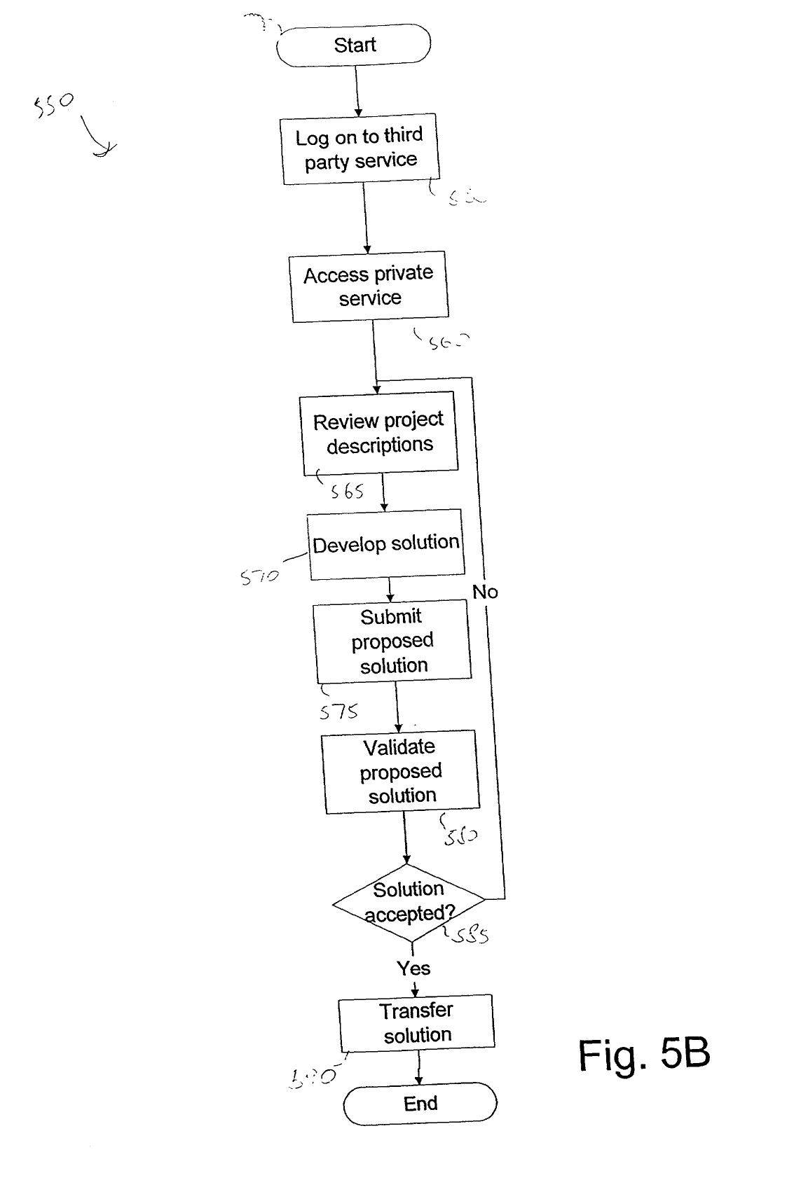

The process 500 of accessing a service provided by computer system 200 (FIG. 2A) for a solution seeker is illustrated by the flow diagram of FIG. 5A. First, the solution seeker logs on to a website providing a third party service in stage 505. In stage 510, the solution seeker accesses a private service (e.g. by clicking on a hyperlink of a web page) on the solution broker's website. Stages 515-540 are analogous to stages 340-390 of FIG. 3A, except that only solution seekers affiliated with the third party service are allowed to participate in the submission of project definitions and proposed solutions. However, the solution seekers and solution providers affiliated with the third party service can only access a database storing project definitions and proposed solutions posted by other solution seekers and solution providers affiliated with the third party service.

Similarly, the process 550 of accessing a service provided by computer system 200 (FIG. 2A) for a solution provider is illustrated by the flow diagram of FIG. 5B. First, the solution provider logs on to a website providing a third party service in stage 505. In stage 510, the solution provider accesses a private service (e.g. by clicking on a hyperlink of a web page) on the solution broker's website. Stages 555-590 are analogous to stages 440-490 of FIG. 4A, except that only solution providers affiliated with the third party service are allowed to participate in the submission of project definitions and proposed solutions.

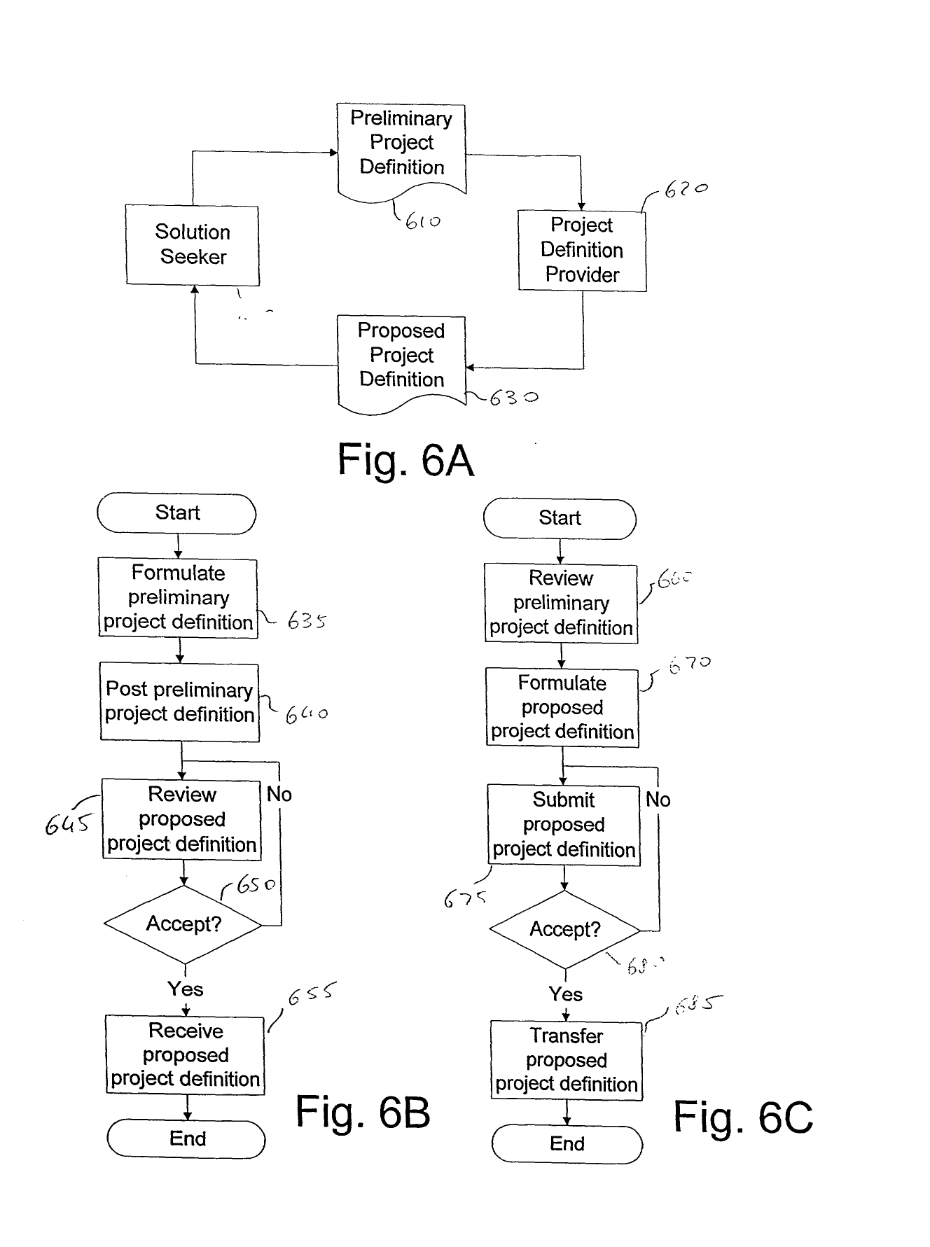

In some embodiments, the solution seeker may enlist the help of a project definition provider in formulating the project definition. The project definition provider is a party that possesses the necessary know-how—or intellectual capital—to assist the solution seeker in defining the problem the solution seeker is facing. The flow of information between the solution seeker and the project definition provider is shown in FIG. 6A. Initially, solution seeker 600 provides a preliminary project definition 610 to project definition provider 620. Project definition provider 620, in turn, provides a proposed project definition 630 to solution seeker 600.

The process of obtaining a project definition is illustrated by the flow diagram of FIG. 6B. First, solution seeker 600 formulates a preliminary project definition 610 in stage 635. Preliminary project definition 610 may be a simple narrative description of the project. Solution seeker 600 then posts the preliminary project definition on a website provided by the solution broker in stage 640. The solution broker evaluates the preliminary project definition against a database of project definition providers and forwards the preliminary definition to appropriate project definition providers. Solution seeker 600 reviews proposed project definitions 630 in stage 645. In stage 650, solution seeker 600 determines whether any of proposed project definitions 630 are acceptable, in which case solution seeker 600 receives the accepted project definition in stage 655. Otherwise, stages 645-655 are repeated.

The process of providing a project definition is illustrated by the flow diagram of FIG. 6C. First, in stage 660, project definition provider 620 reviews preliminary project definitions 610. Then, in stage 670, project definition provider 620 formulates a proposed project definition 630 based on preliminary project definition 610. Proposed project definition 630 is then submitted in stage 675. In stage 680, solution seeker 600 determines whether proposed project definition 630 is acceptable, in which case, project definition provider 620 transfers proposed project definition 630 to solution seeker 600 in stage 685. Otherwise, stages 675-685 are repeated.

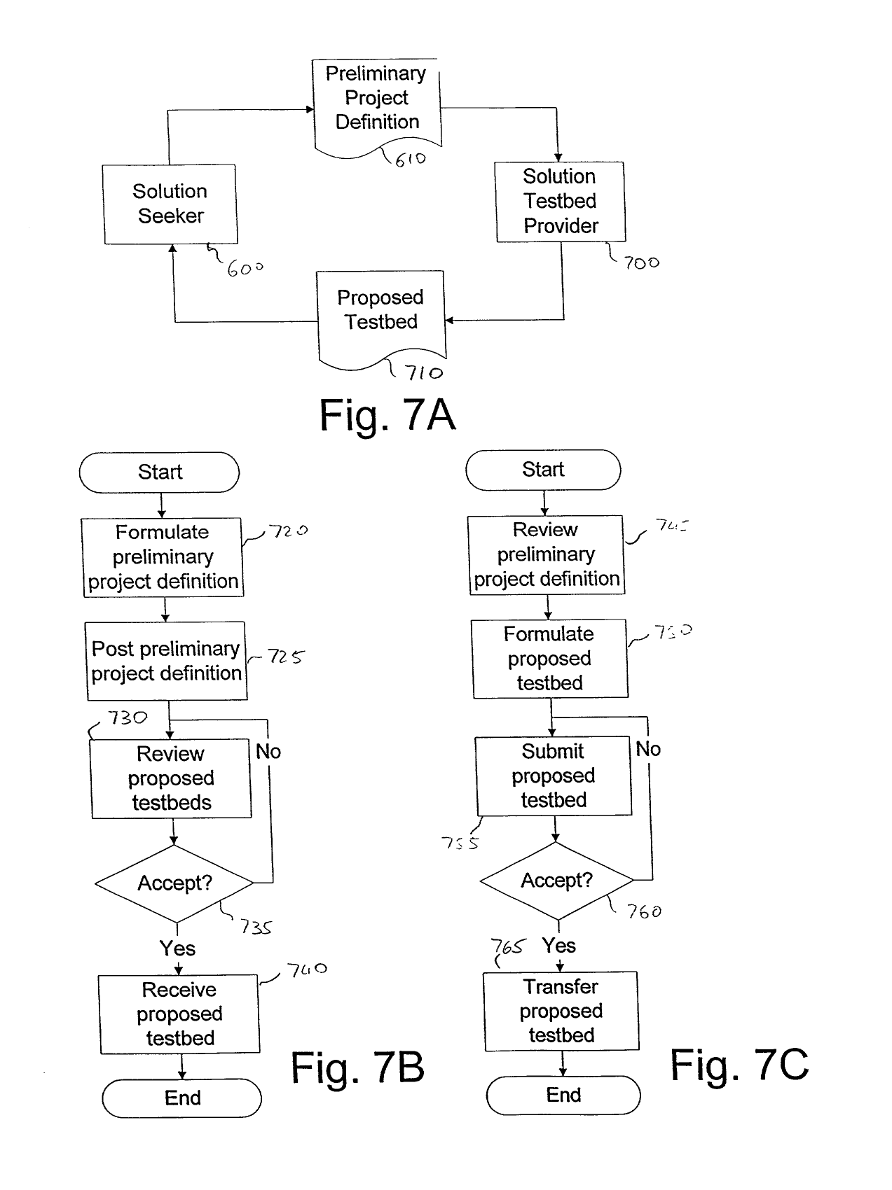

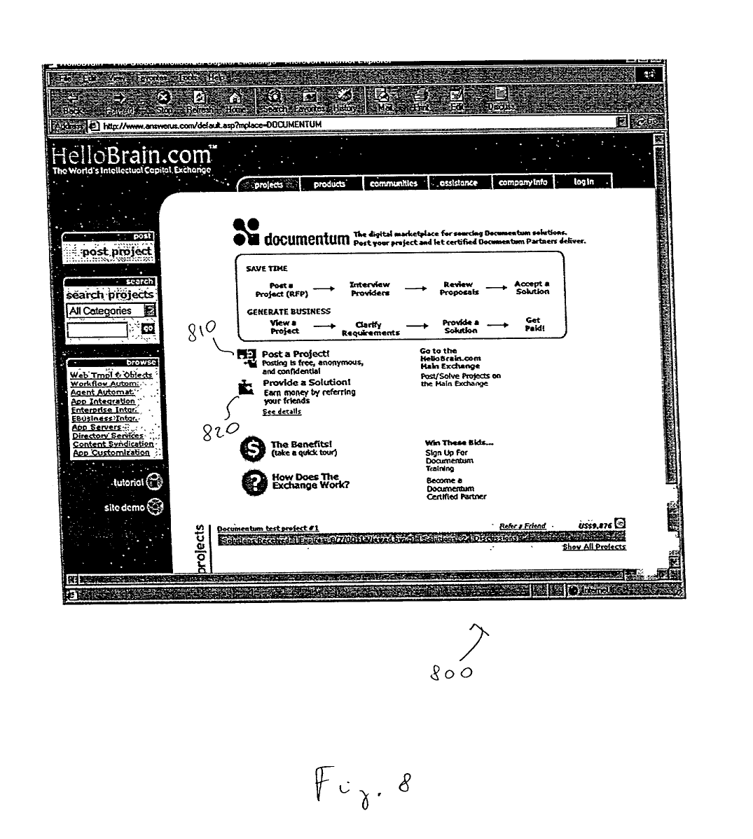

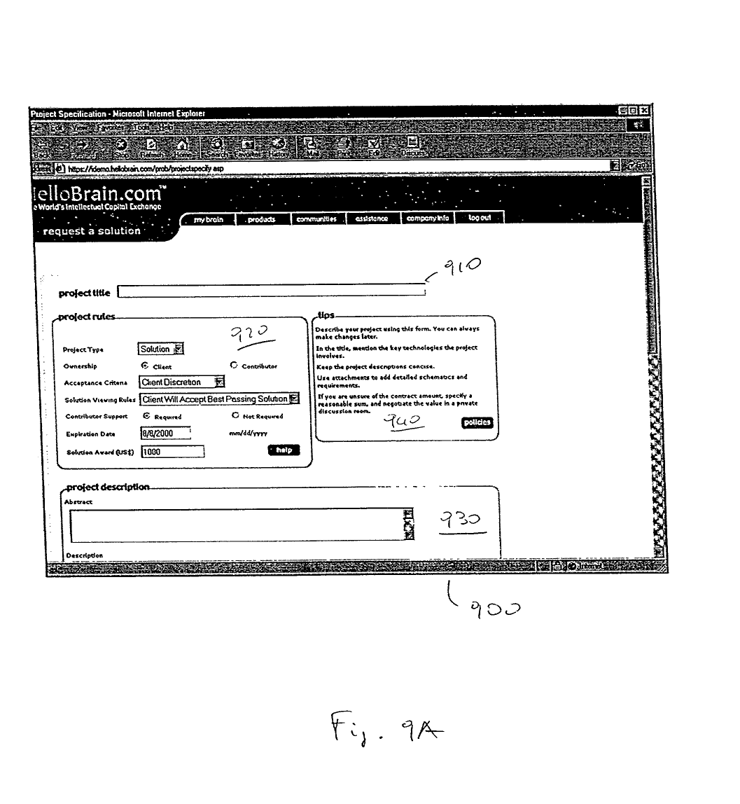

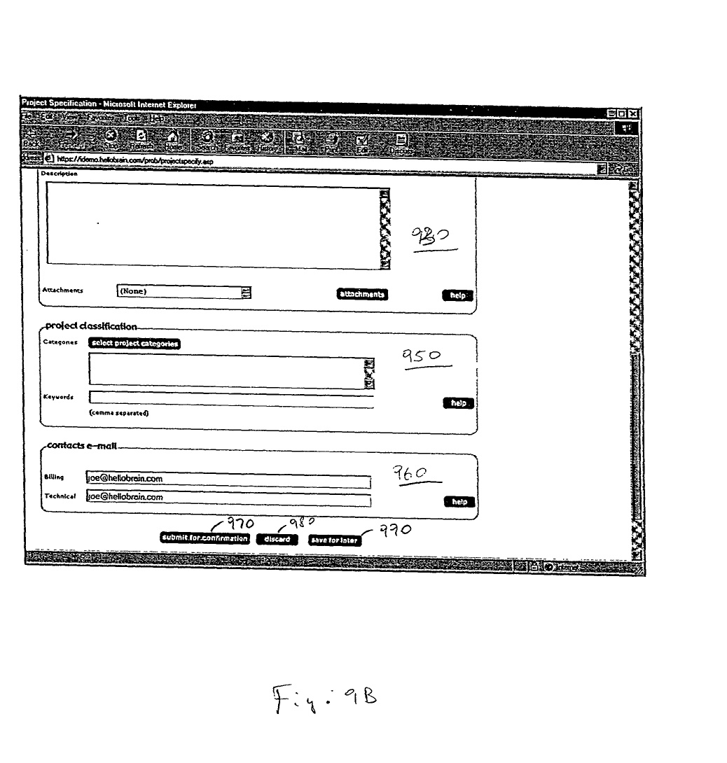

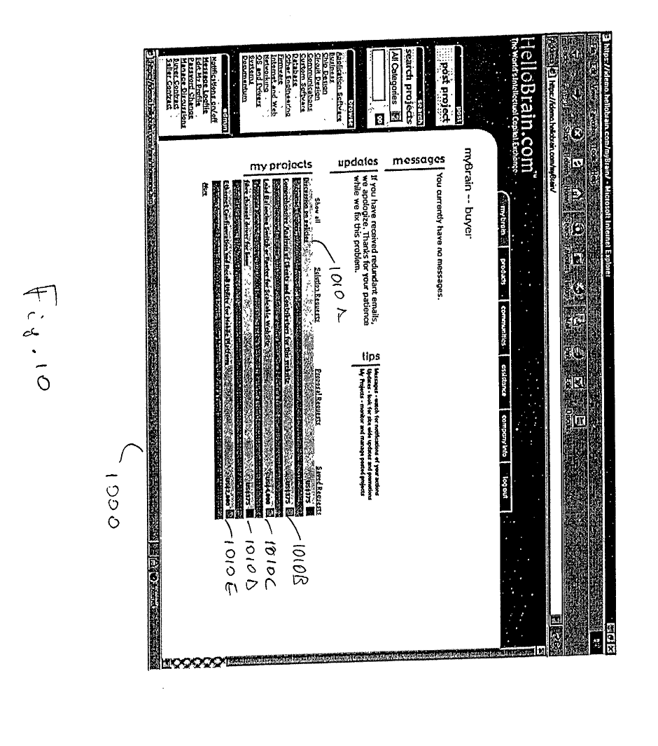

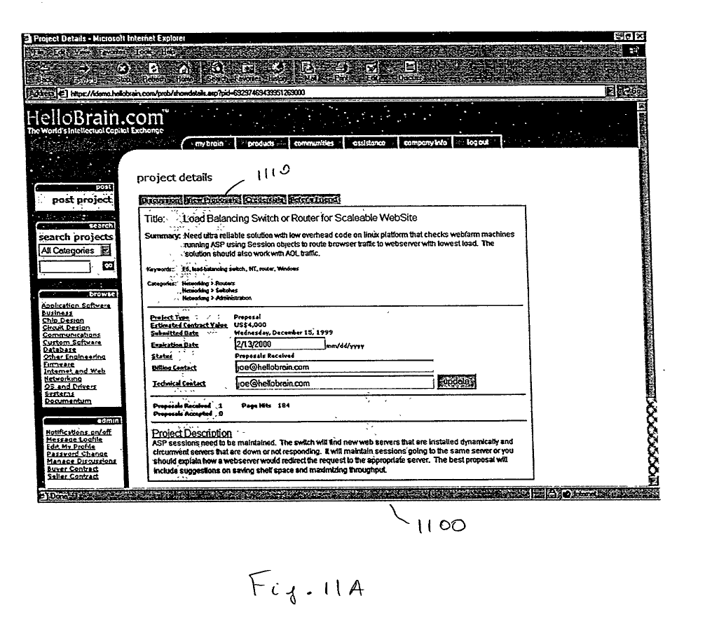

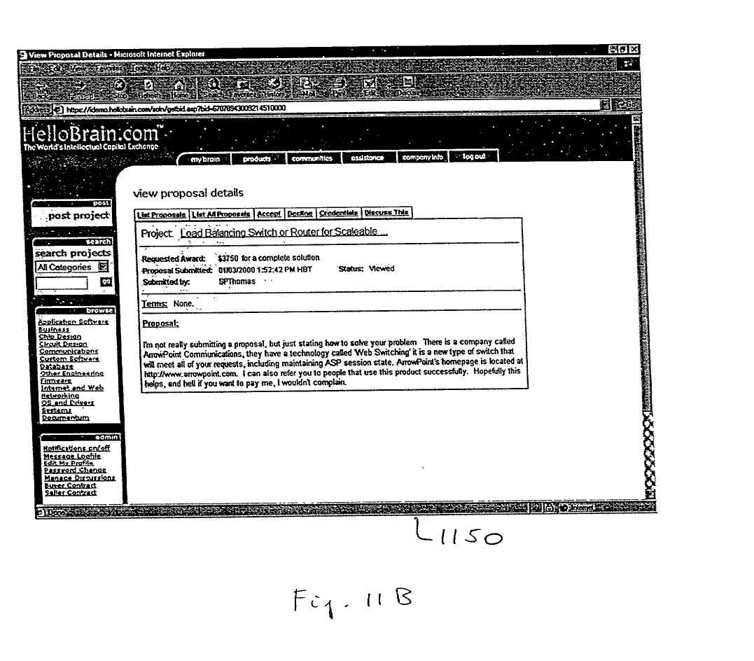

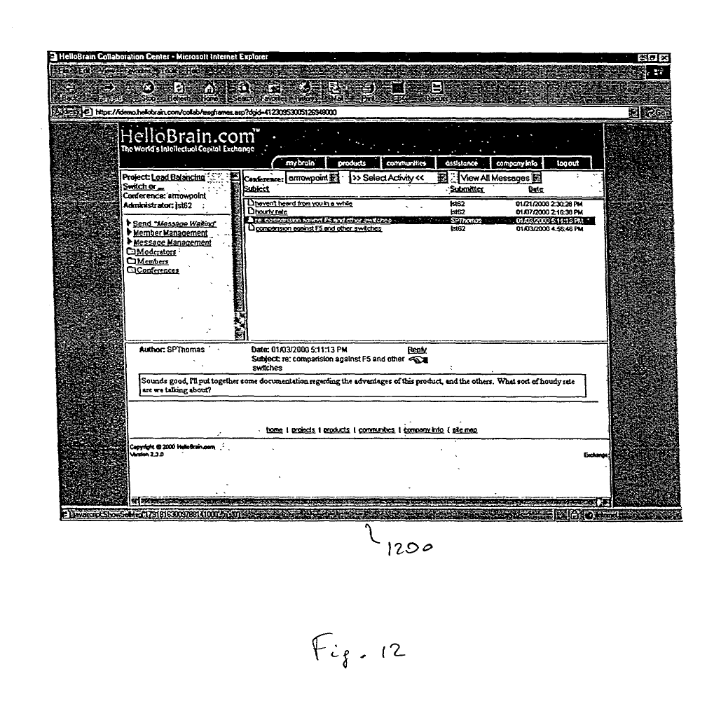

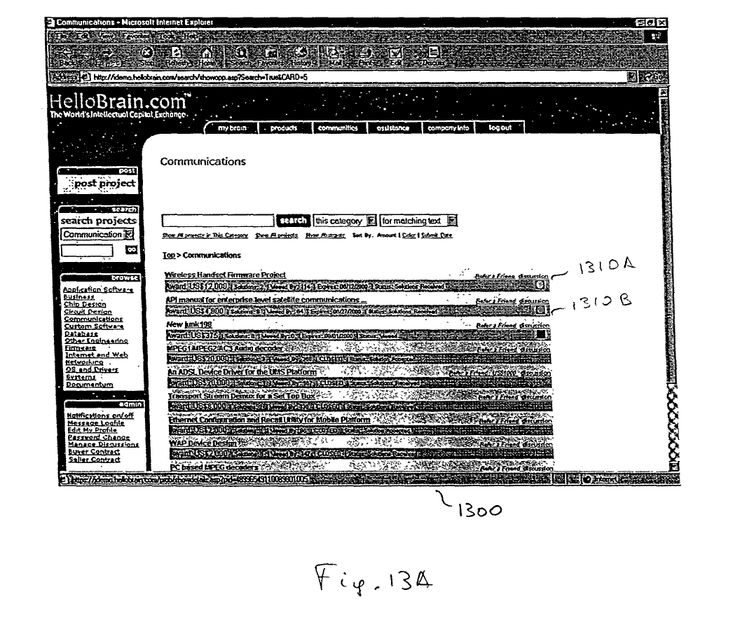

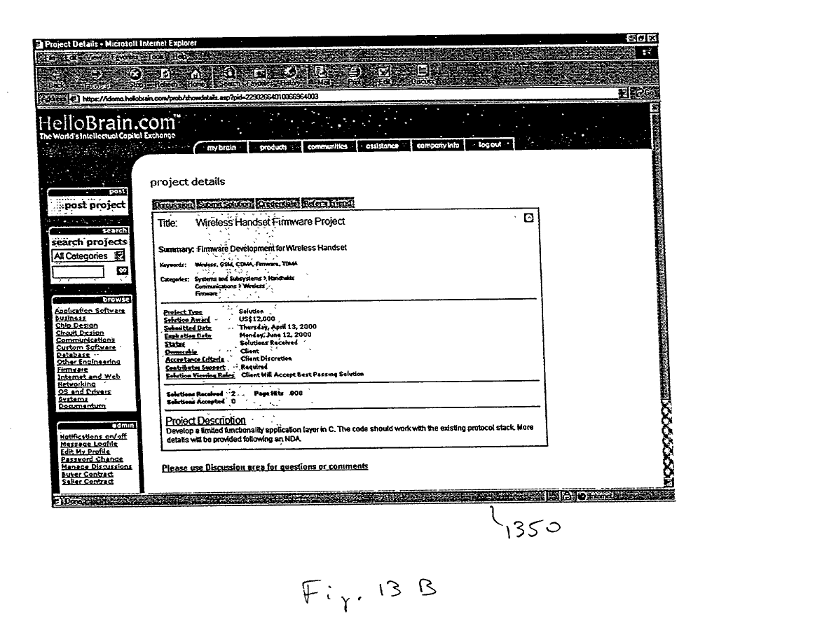

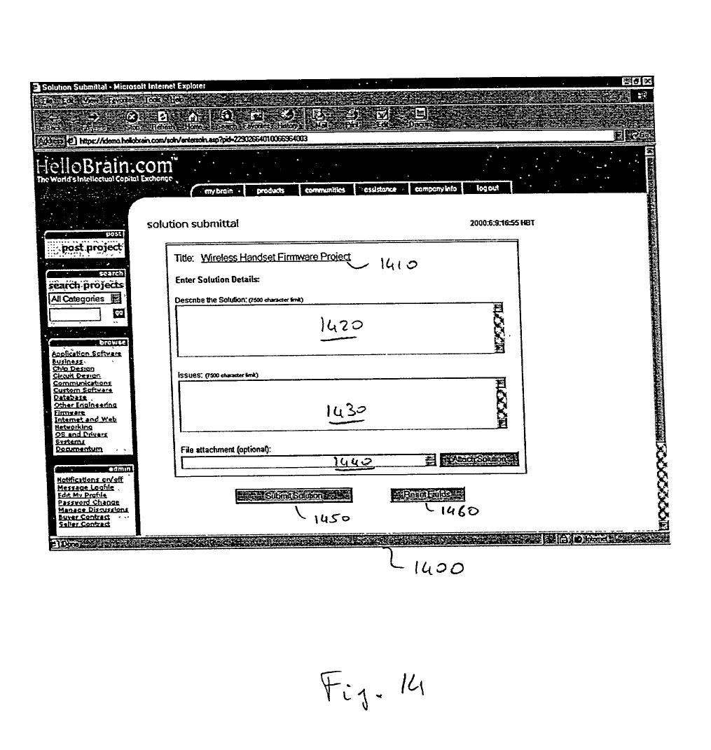

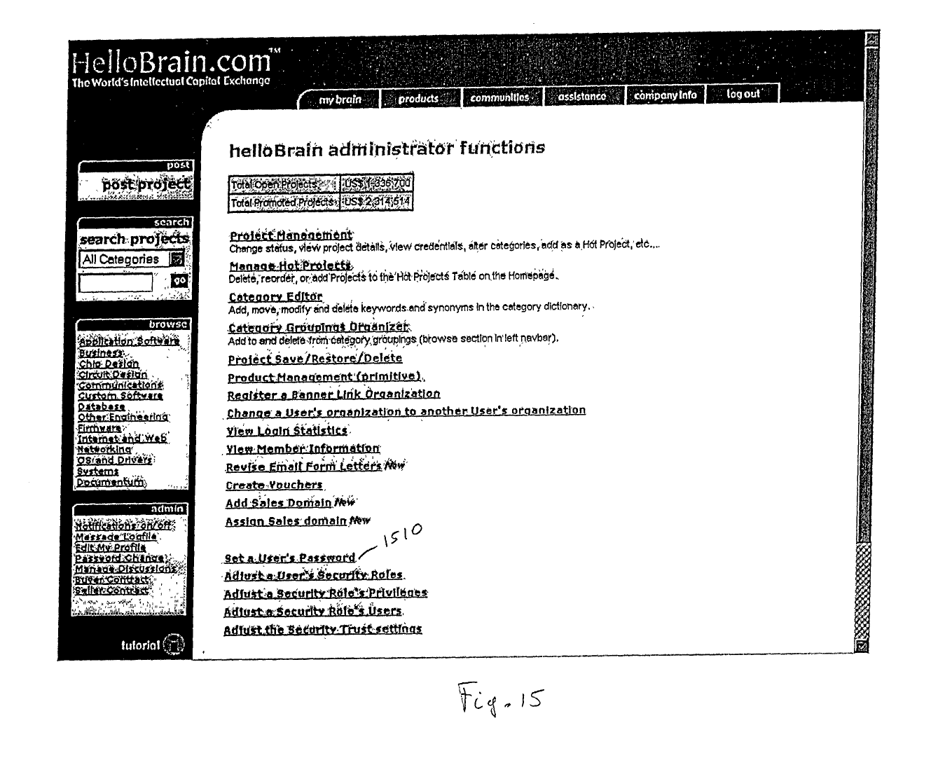

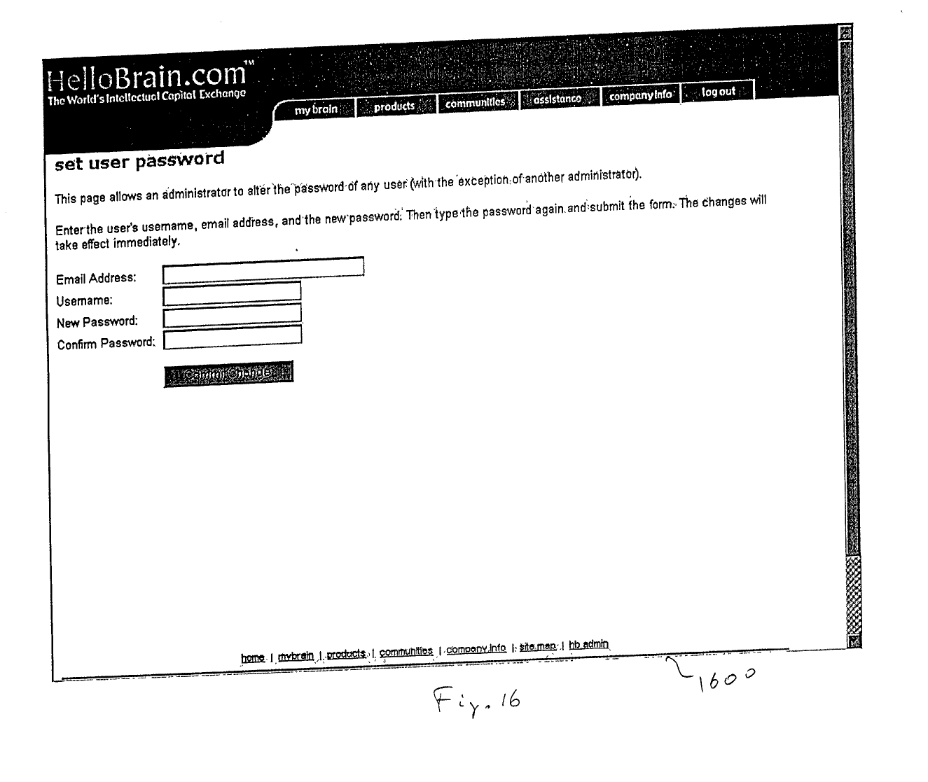

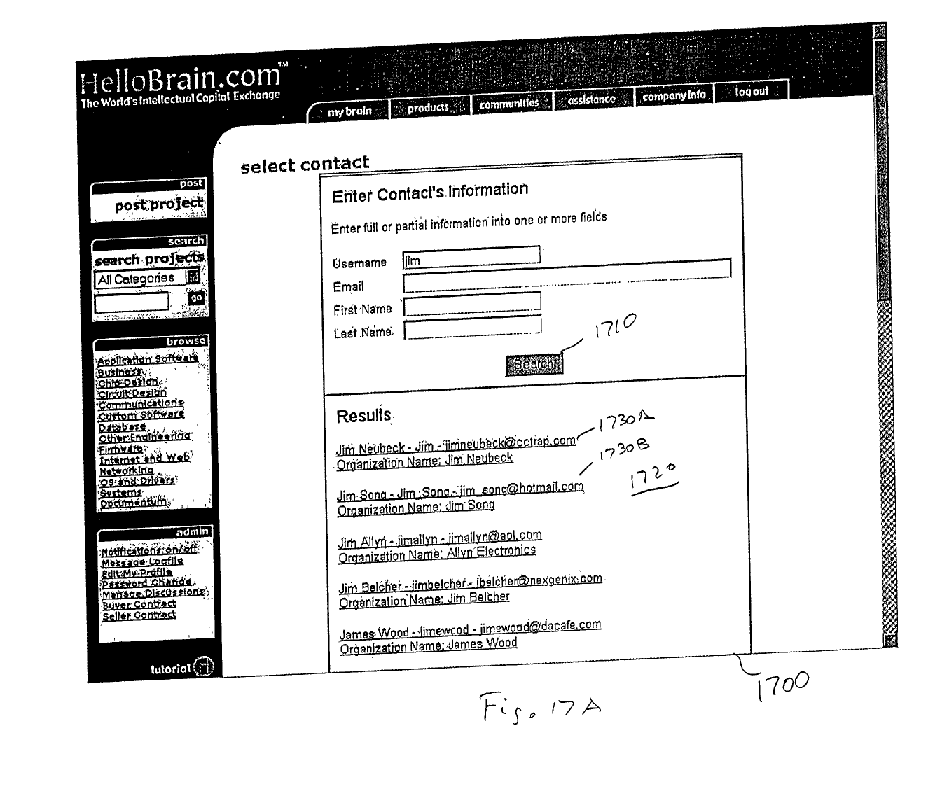

In addition, the solution seeker may enlist the help of a solution testbed provider in formulating a solution testbed. The flow of information between the solution seeker and the solution testbed provider is shown in FIG. 7A. Initially, solution seeker 600 provides a preliminary project definition 610 to solution testbed provider 700. Solution testbed provider 700, in turn, provides a proposed testbed 710 to solution seeker 600.

The process of obtaining a solution testbed is illustrated by the flow diagram of FIG. 7B. First, solution seeker 600 formulates a preliminary project definition 610 in stage 720. Solution seeker 600 then posts the preliminary project definition on a website provided by the solution broker in stage 725. The solution broker evaluates the preliminary project definition against a database of solution testbed providers and forwards the preliminary definition to appropriate solution testbed providers. Solution seeker 600 reviews proposed testbeds 710 in stage 730. In stage 735, solution seeker 600 determines whether any of proposed testbeds 710 are acceptable, in which case solution seeker 600 receives the accepted solution testbed in stage 740. Otherwise, stages 730-740 are repeated.

The process of providing a solution testbed is illustrated by the flow diagram of FIG. 7C. First, in stage 745, solution testbed provider 700 reviews preliminary project definitions 610. Then, in stage 750, solution testbed provider 700 formulates a proposed testbed 710 based on preliminary project definition 610. Proposed testbed 710 is then submitted in stage 755. In stage 760, solution seeker 600 determines whether proposed testbed 710 is acceptable, in which case, solution testbed provider 700 transfers proposed testbed 710 to solution seeker 600 in stage 765. Otherwise, stages 755-765 are repeated.

A ratings and rewards system similar to the one described above for solution seekers and solution providers is also used for project definition providers and solution testbed providers. Similarly, “virtual notary” and escrow services are provided by the solution broker for transfer of information between solution seekers 600 and project definition providers 620 or solution testbed providers 700.

FIG. 8 shows a web page 800 of a third party service provider. Web page 800 would be used by solution seekers and solution providers to perform the operations of FIGS. 5A and 5B. Web page 800, in turn, provides hyperlinks 810 and 820 that enable solution seekers and solution providers to access the private service of stages 510 and 560, as explained above. Following hyperlink 810 causes web page 900 (FIGS. 9A and 9B) to be displayed onto client computer 120. Web page 900 includes a title field 910, project rules pane 920, a project description pane 930, a tips pane 940, a project classification pane 950, a contacts e-mail pane 960, submit button 970, discard button 980 and save button 990.

Web page 900 allows a solution seeker to input a project definition by entering the appropriate information in title field 910, project description pane 930, and project classification pane 950. The solution seeker may also specify project rules or provide e-mail contact information. The solution seeker then submits the project definition by pressing submit button 980. Alternatively, the solution seeker may either cancel the project definition by pressing discard button 980 or save the entered information for later submission by pressing save button 990.

Once a project definition is submitted, the solution seeker may periodically review any posted solution for his/her project definitions as shown on web page 1000 (FIG. 10). The solution seeker can view further details for each of the project definitions by selecting a list item 1010n (where n=A, B, C, etc.). FIG. 11A illustrates a project detail web page 1100 shown in response to the solution seeker selecting list item 1010C of FIG. 10. The solution seeker may further access a proposal details web page 1150 (FIG. 11B) by following hyperlink 1110 on web page 1100. If the solution seeker is interested in further pursuing the solution providers proposal, he may contact the solution provider via a chat room, such as the one shown in FIG. 12. Project discussion web page 1200 allows the solution seeker to conduct both public and private discussions with solution providers to determine if any he is interested in any of the proposals.

FIG. 13 illustrates a project search web page 1300. As explained above with respect to the flow diagrams of FIGS. 3 and 4, project definitions are forwarded to solution providers according to the solution provider' profiles. However, solution providers may also choose to search and browse through additional project definitions that are not directly referred to them. Web page 1300 allows solution providers to search project definition listings. The solution seeker can view the project details by following a list item 1310n (where n=A, B, C, etc.). A project details web page 1350 (FIG. 13B) is shown in response to the solution provider selecting list item 1310A.

If the solution provider is interested in submitting a solution for the project, the solution provider can enter a description for his solution on solution web page 1400 (FIG. 14). Solution web page 1400 includes a project title field 1410, a solution description field 1420, an issues field 1430, a file attachment field 1440, a submit button 1450 and a reset button 1460. To submit a proposed solution, the solution provider fills in a solution description field 1420. The solution provider may also choose to specify any issues or provide a file attachment with further details about his/her proposed solution. The solution provider then submits his proposed solution by pressing submit button 1450. Alternatively, the solution provider may choose to reset the fields on web page 1400 by pressing reset button 1460.

FIGS. 15-18B illustrate web pages used to administer privileges on the private service of FIG. 2A. Of course, a similar mechanism to administer user privileges may also be used in connection with the service of FIGS. 1A and 1B. Administrator functions web page 1500 (FIG. 15) allows an administrator to navigate to other web pages providing security control functions for the private exchange service. For example, selecting hyperlink 1510 on web page 1500 allows the administrator to access set user password web page 1600 (FIG. 16). The administrator can then set a new password for any user of the private exchange service by specifying the user's e-mail address, username and password on web page 1600.

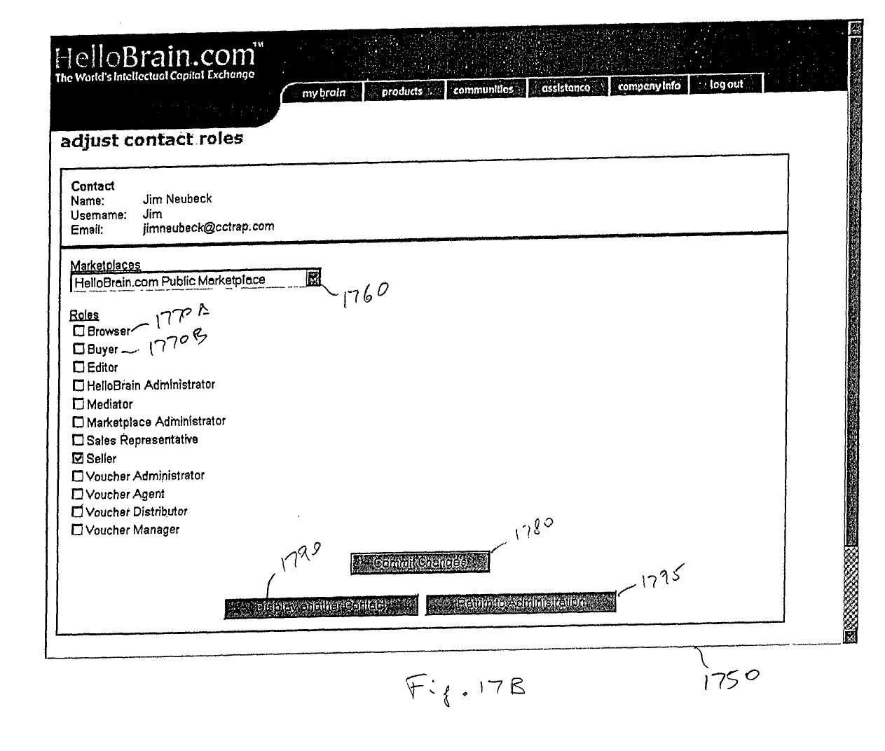

The administrator may also search for contact information using select contact web page 1700 (FIG. 17A) by specifying any combination of the contact's username, e-mail address, first and last name and pressing search button 1710. Matching results are then shown in results area 1720 as hyperlinks. The administrator can access a contact role web page 1750 (FIG. 17B) by following a hyperlink 1730n (where n=A, B, C, etc.). The administrator can then modify the contact roles for a contact using adjust contact role web page 1750. Adjust contact role web page 1750 includes a marketplace pulldown menu 1760 and a plurality of checkboxes 1770n , each corresponding to a role. The administrator then selects which roles should be granted to the contact by checking the appropriate checkboxes 1770n and pressing a commit button 1780. Alternatively, the administrator may display contact roles for a different contact or return to administrator functions web page 1500 by pressing buttons 1790 or 1795, respectively.

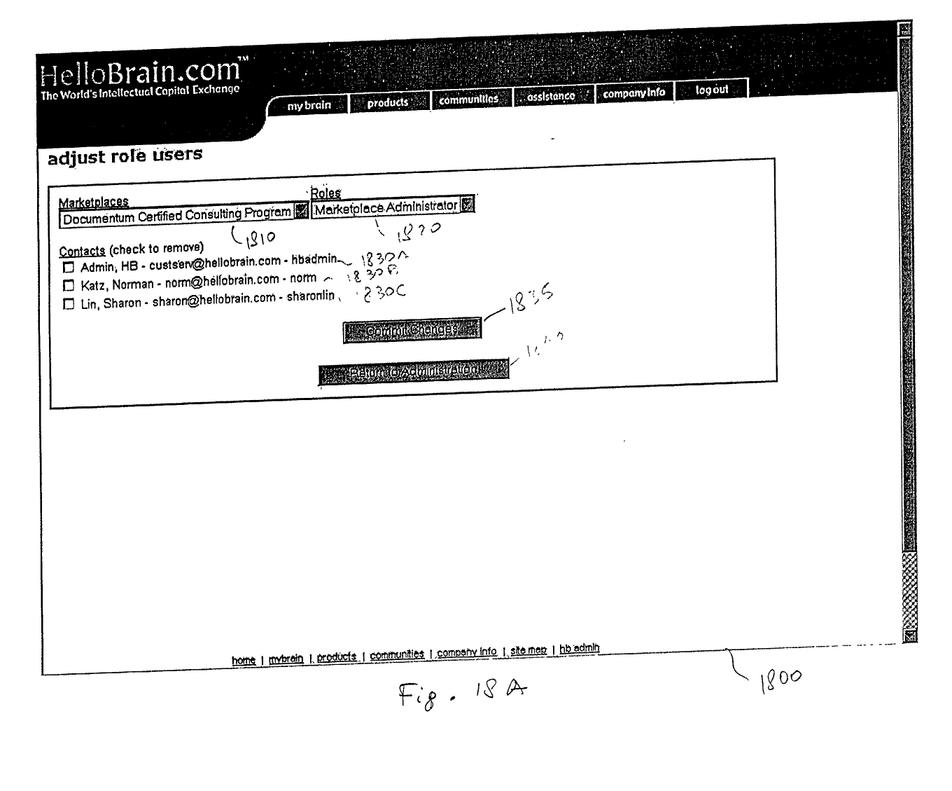

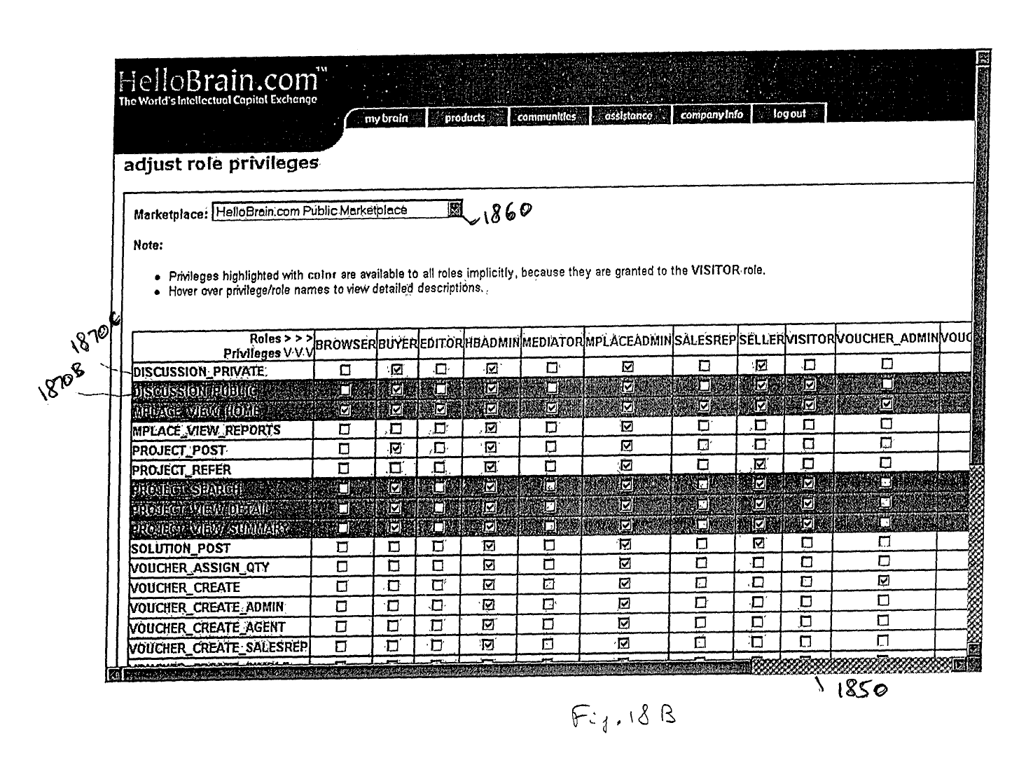

The administrator may also assign different roles to users via adjust role users web page 1800 (FIG. 18A). Web page 1800 includes a marketplace pulldown menu 1810, a roles pulldown menu 1820, a plurality of user checkboxes 1830n , a commit button 1835 and a return button 1840. The administrator can adjust the roles for a given user by selecting a checkbox 1830n corresponding to the user and corresponding marketplace and roles from pulldown menus 1810 and 1820 and then pressing commit button 1835. Alternatively, the administrator may return to administrator functions web page 1500 by pressing button 1840.

The administrator may further adjust privileges for each role for a given marketplace using adjust role privileges web page 1850 (FIG. 18B). Web page 1850 includes a marketplace pulldown menu 1860 and a plurality of checkboxes 1870n . Finally, the administrator can adjust security trust using adjust security trust web page 1875 (FIG. 18C). Web page 1875 includes a marketplace pulldown menu 1880, a plurality of role checkboxes 1890n and a plurality of privilege checkboxes 1895n . The administrator can assign privileges to specific roles for a marketplace by selecting a marketplace from pulldown menu 880 and checking corresponding boxes 1890n and 1895n .

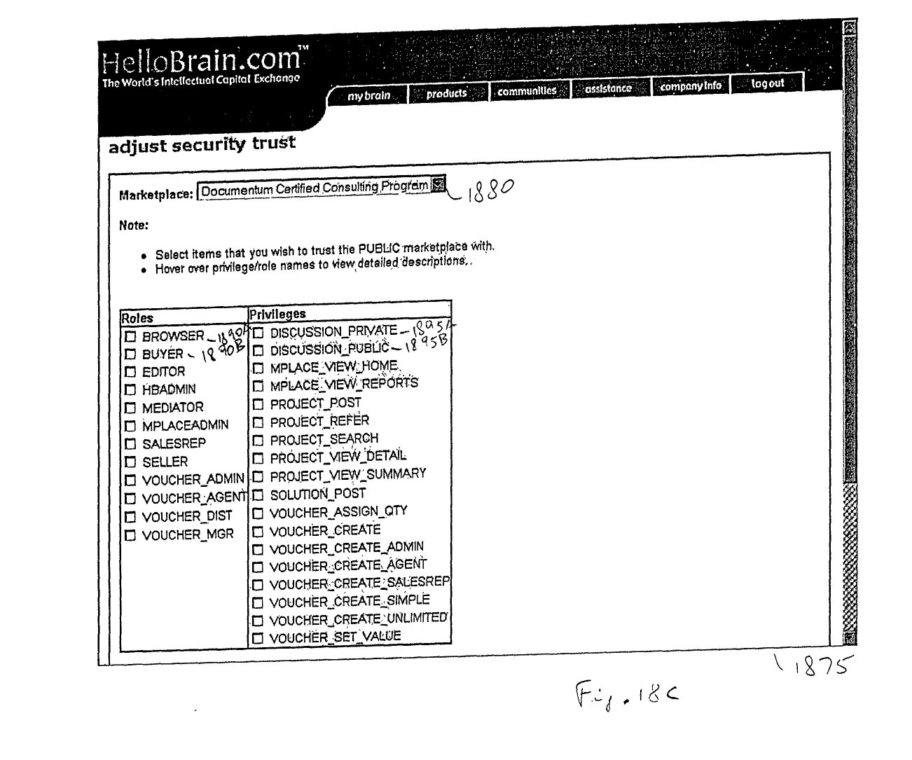

FIG. 19 illustrates a submit token wep page 1900 that can be used with the private exchange service of FIG. 2A. Using web page 1900, users are granted access to the private exchange service by providing an access token in token field 1910 and pressing submit button 1920. Once the token is validated by the private exchange service, the token is added to the user's profile allowing the user to access the private exchange service at a later time, without having to resubmit the token.

Embodiments described above illustrate but do not limit the invention. For example, the invention is not limited to the specific graphical user interface or the design and layout of the web pages described herein. In fact, several alternative graphical user interfaces are possible. In addition, the stages of the flow diagrams described herein can be performed in an arbitrary order, unless otherwise indicated by the logical dependencies of the operations performed in such stages. As a result, the present invention is not limited to any specific order of the operations described in the flow diagrams. Numerous modifications and variations are possible in accordance to the principles of the present invention, as described by the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A method for capturing information, the method comprising:
providing a service to exchange information using digital collaboration; and
automatically capturing information exchanged between users of the service.

2. The method of claim 1, wherein the information captured includes the context in which the information was exchanged between the users of the service.

3. The method of claim 1, further comprising:
replaying at least a portion of the captured information.

4. The method of claim 3, wherein the information replayed includes the context in which the information was exchanged between the users of the service.

5. The method of claim 1, wherein the information captured is exchanged between solution seekers and solution providers.

6. The method of claim 1, wherein the information is captured using a client computer program installed on a client computer used by a user of the service.

7. The method of claim 6, wherein the client computer program is an applet.

8. The method of claim 6, wherein the client computer program is downloaded from a server computer onto the client computer and installed on the client computer when the user of the service begins using the service.

9. The method of claim 1, further comprising inserting one or more tags into the captured information.

10. The method of claim 9, wherein the tags are XML tags.

11. The method of claim 9, wherein the tags are inserted in an IP packet transmitted from the client computer to the server computer.

12. The method of claim 11, wherein the tags are inserted in a payload portion of the IP packet.

13. The method of claim 12, wherein the tags indicate a type of communication used during digital collaboration.

14. The method of claim 6, further comprising capturing a source of the information captured during digital collaboration.

15. The method of claim 14, wherein the source of the information captured during digital collaboration is part of the context of the digital collaboration.

16. A computer system for digital collaboration, the computer system comprising:
a server computer connected to at least one client computer via a global-area computer network; and
a server computer program executed by the server computer, wherein the server computer further includes computer instructions for:
providing a service for exchanging information using digital collaboration; and
automatically capturing information exchanged between users of the service.

17. The computer system of claim 16, wherein the information captured includes the context in which the information was exchanged between the users of the service.

18. The computer system of claim 16, wherein the server computer program further comprises computer instructions for:
replaying at least a portion of the captured information.

19. The computer system of claim 18, wherein the information replayed includes the context in which the information was exchanged between the users of the service.

20. The computer system of claim 16, wherein the information captured is exchanged between solution seekers and solution providers.

21. The computer system of claim 16, wherein the information is captured using a client computer program installed on a client computer used by a user of the service.

22. The computer system of claim 21, wherein the client computer program is an applet.

23. The computer system of claim 21, wherein the client computer program is downloaded from a server computer onto the client computer and installed on the client computer when the user of the service begins using the service.

24. The computer system of claim 1 6, wherein the client computer program further comprises computer instructions for inserting one or more tags into the captured information.

25. The computer system of claim 24, wherein the tags are XML tags.

26. The computer system of claim 24, wherein the tags are inserted in an IP packet transmitted from the client computer to the server computer.

27. The computer system of claim 26, wherein the tags are inserted in a payload portion of the IP packet.

28. The computer system of claim 27, wherein the tags indicate a type of communication used during digital collaboration.

29. The computer system of claim 21, wherein the server computer program further comprises computer instructions for capturing a source of the information captured during digital collaboration.

30. The computer system of claim 29, wherein the source of the information captured during digital collaboration is part of the context of the digital collaboration.
